(19) United States
(12) Patent Application Publication
(10) Pub. No.: US 2024/0427086 A1
(43) Pub. Date: Dec. 26, 2024

(54) LINKAGE CHAIN FOR STORING AND ROUTING FIBER OPTIC CABLES AND METHOD OF USING SAME

(71) Applicant: CORNING RESEARCH & DEVELOPMENT CORPORATION, Corning, NY (US)

(72) Inventors: Jason Cameron Payne, Fort Worth, TX (US); Karyne Poissant Prevratil, Fort Worth, TX (US); Joshua Thomas Smith, Mooresville, NC (US)

(21) Appl. No.: 18/743,692

(22) Filed: Jun. 14, 2024

Related U.S. Application Data
(60) Provisional application No. 63/521,984, filed on Jun. 20, 2023.

(51) Int. Cl. G02B 6/36; G02B 6/44

(52) U.S. Cl. CPC G02B 6/3616; G02B 6/4403

(57) ABSTRACT

A linkage for releasably securing a fiber optic cable is provided. The linkage includes a central body having a longitudinal axis. The linkage also includes at least two cuffs that are each operatively connected to the central body. Each cuff is defined by a top face, a bottom face, and a lateral face. The lateral face includes an opening such that each cuff is configured to releasably receive a portion of the cable therein. The at least two cuffs includes a first cuff and a second cuff. The first cuff and the second cuff extend in opposing directions transverse to the longitudinal axis of the central body. A cable arrangement including at least two linkages joined together to form a linkage chain and a method for using the linkage chain to releasably secure at least one cable are also provided.

### PRIORITY APPLICATION

This application claims the benefit of priority of U.S. Provisional Application No. 63/521,984, filed on Jun. 20, 2023, the content of which is relied upon and incorporated herein by reference in its entirety.

### TECHNICAL FIELD

This disclosure relates generally to fiber optic cables and fiber optic connectivity, and more particularly to a multi-use device for storing and routing fiber optic cables and a method of using the same.

### BACKGROUND

The large amount of data and other information transmitted over the internet has led businesses and other organizations to develop large scale data centers for organizing, processing, storing, and/or disseminating large amounts of data. Data centers contain a wide range of information technology (IT) equipment including, for example, servers, networking switches, routers, storage subsystems, etc. Data centers further include a large amount of cabling and hardware to organize and interconnect the IT equipment in the data center. Modern data centers may include multi-building campuses having, for example, one primary or main building and a number of auxiliary buildings in close proximity to the main building. All the buildings on the campus are interconnected by a local fiber optic network. Cables may be routed through conduits, ducts, raceways, etc. (“pathways”) within and between the buildings.

To route the fiber optic cables through the pathways during installation within and between buildings, one end of the fiber optic cables are typically provided with a pull grip assembly (often referred to as a “pull grip” or “pulling grip”). A tension member that extends through the pathway is coupled to the pulling grip and the fiber optic cables are pulled through the pathway by the tension member. Alternatively or additionally, the fiber optic cables may be blown or jetted through the pathways. After the fiber optic cables are routed to a desired location, it may be necessary to store (or “park”) the fiber optic cables (or a portion thereof) in anticipation of use. For example, a high fiber count fiber optic cable (e.g., a trunk cable) may split into a number of smaller subunit fiber optic cables (also referred to as legs or branches). Bandwidth demand may not initially require the use of all of the subunit fiber optic cables. In such a case, the “waiting to be used” subunit fiber optic cables must be stored (or “parked”) near the hardware or other network equipment until they are needed.

While current implementations of pulling grips and storage (or “parking”) solutions for fiber optic cables are generally satisfactory for their intended purpose, with increased demand for bandwidth, manufacturers and installers have identified a number of drawbacks to existing arrangements. For example, existing pulling grips are typically discarded after use. This results in a large amount of waste (in the form of discarded pulling grips) to deal with after routing a number of fiber optic cables. Further, existing solutions for storing (or “parking”) fiber optic cables near to network equipment must be separately provided and typically take up a large amount of space. Moreover, fiber optic architectures are becoming more and more dense (e.g., more fiber optic fibers and connections in the same amount of space) in terminals, cabinets, and other hardware. This makes providing space for storage (or “parking”) devices or solutions, for example, a significant design challenge.

With this in mind, there is a desire to provide a solution for routing and storing (or “parking”) fiber optic cables that can reduce waste (e.g., pulling grip waste) and address inefficiencies (e.g., space, time, etc.) in fiber optic cable installation.

### SUMMARY

In one aspect of the disclosure, a linkage for releasably securing a cable, such as a fiber optic cable, is disclosed. The linkage includes a central body having a longitudinal axis and at least two cuffs. Each cuff of the at least two cuffs is operatively connected to the central body. Each cuff is defined by a top face, a bottom face, and a lateral face. The lateral face has an opening such that each cuff is configured to releasably receive a portion of the cable therein. Further, the at least two cuffs includes a first cuff and a second cuff. The first cuff and the second cuff extend in opposing directions transverse to the longitudinal axis of the central body.

In one embodiment, the radius of the first cuff at the top face may be greater than the radius of the first cuff at the bottom face. Further, the radius of the second cuff at the top face may be greater than the radius of the second cuff at the bottom face.

In one embodiment, the at least two cuffs may also include a third cuff. The third cuff may extend in the same direction as the first cuff and may be aligned with the first cuff. Further, the radius of the third cuff at the top face may be greater than the radius of the third cuff at the bottom face. Further, the radius of the first cuff at the bottom face may be greater than the radius of the third cuff at the top face. Further, the second cuff may be located between the first cuff and the third cuff along the longitudinal axis of the central body.

In one embodiment, the opening in the lateral face of the first cuff and the opening in the lateral face of the second cuff may be in opposing directions transverse to the longitudinal axis of the central body. Further, the opening in the lateral face of the third cuff may be in the same direction as the opening in the lateral face of the first cuff. In another embodiment, the linkage may include a labeling space.

In another aspect of the disclosure, a cable arrangement that uses a linkage chain is disclosed. The cable arrangement includes the linkage chain, a first cable, and a second cable. The linkage chain comprises a first linkage and a second linkage that each include a central body and a first cuff, a second cuff, and a third cuff operatively connected to the central body. Each of the first cuff, the second cuff, and the third cuff has a lateral face with an opening so as to be configured to releasably receive a portion of the first cable or the second cable therein. Additionally, the first cuff and the third cuff extend from the central body in a direction opposite that of the second cuff. Further, the first cable is releasably received by the first cuff and third cuff of the first linkage. The second cable is releasably received by the second cuff of the first linkage and by the first cuff and the third cuff of the second linkage to form a portion of the linkage chain.

In one embodiment, the second cuff of the first linkage may be located between the first cuff and the third cuff of the second linkage.

In one embodiment, the cable arrangement may further include a third cable and a third linkage. The second cable may be releasably received by the first cuff and the third cuff of the third linkage. The third cable may be releasably received by the second cuff of the second linkage and by the first cuff and the third cuff of the third linkage to form part of the linkage chain.

In some embodiments, the first cable and the second cable are each fiber optic cables that include a fiber optic connector on an end thereof. The first cuff, the second cuff, and the third cuff each releasably receive a portion of the fiber optic connector of the first cable or the second cable therein.

In a further aspect of the disclosure, a method of arranging at least two cables using a linkage chain that includes at least a first linkage and a second linkage is provided. The first linkage and the second linkage each include a central body and a first cuff, a second cuff, and a third cuff operatively connected to the central body. The method includes releasably securing a first cable of the at least two cables to the first cuff and the third cuff of the first linkage. The method also includes releasably securing a second cable of the at least two cables to the second cuff of the first linkage and to the first cuff and the third cuff of the second linkage to form a portion of the linkage chain.

In one embodiment, the first cable and the second cable are each fiber optic cables that include a fiber optic connector on an end thereof. The first cuff, the second cuff, and the third cuff each releasably secure a portion of the fiber optic connector of the first cable or the second cable therein.

In one embodiment, the step of releasably securing the second cable includes receiving the second cuff of the first linkage on the second cable at a longitudinal location on the second cable that is above or below where the second linkage is received on the second cable.

In one embodiment, the method may further include pivoting the first linkage towards the second linkage about the second cable to reduce an overall outer diameter of the linkage chain. Further, the method may include routing the linkage chain through a pathway after the step of pivoting the first linkage.

In one embodiment, the method may further include removing the first linkage from the second cable. Further, the step of removing the first linkage may include sliding the second cable longitudinally relative to the first linkage and the second linkage. Further, the method may further include releasably securing the first linkage to a third cable after the step of removing the first linkage from the second cable.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a schematic illustration of a data center campus according to an embodiment of the disclosure.

FIG. 2 is a front view of a linkage chain according to an embodiment of the disclosure.

FIG. 3 is a plan view of the linkage chain of FIG. 2.

FIG. 4 is a perspective view of a linkage according to an embodiment of the disclosure.

FIG. 5 is a front view of the linkage of FIG. 4.

FIG. 6 is a plan view of a linkage chain bundle according to an embodiment of the disclosure.

FIG. 7 is a perspective view of an alternative embodiment of a linkage chain bundle according to an embodiment of the disclosure.

FIG. 8 is an alternative perspective view of the linkage chain bundle of FIG. 7, with the fiber optic connectors added for illustrative purposes.

### DETAILED DESCRIPTION

The exemplary embodiments described herein are provided for illustrative purposes and are not limiting. Other exemplary embodiments are possible, and modifications may be made to the exemplary embodiments within the scope of the present disclosure. Therefore, the description below is not meant to limit the scope of the present disclosure. In general, the description relates to a linkage chain for routing and/or storing (or “parking”) fiber optic cables. The linkage chain includes a number of linkages, each linkage releasably secured to a portion of a fiber optic cable, such as to a fiber optic connector on an end of the fiber optic cable. The individual linkages are joined together to form the linkage chain. The linkage chain (with the fiber optic cables secured thereto) may then be used to route and/or store (or “park”) the fiber optic cables, as will be described in greater detail below. The use of the linkage chain to route and/or store (or “park”) the fiber optic cables reduces waste and facilitates greater space and time efficiencies, as will be described in greater detail below.

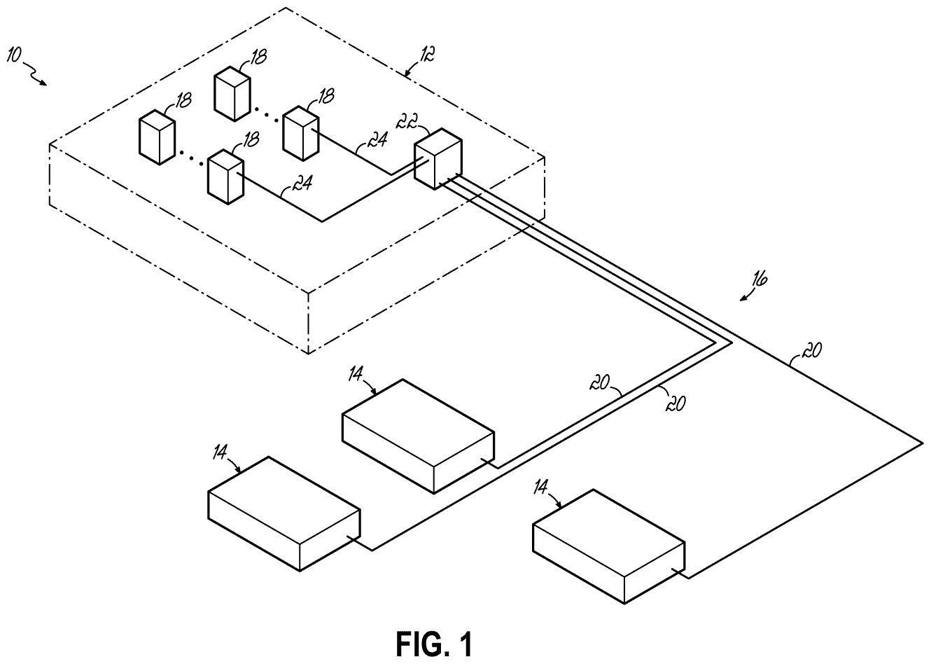

As illustrated in FIG. 1, a modern-day data center 10 may include a collection of buildings (referred to as a data center campus) having, for example, a main building 12 and one or more auxiliary buildings 14 in close proximity to the main building 12. While three auxiliary buildings 14 are shown, there may be more or less depending on the size of the campus. The data center 10 provides for a local fiber optic network 16 that interconnects the auxiliary buildings 14 with the main building 12. The local fiber optic network 16 allows network equipment 18 in the main building 12 to communicate with various network equipment (not shown) in the auxiliary buildings 14. In the exemplary embodiment shown, the local fiber optic network 16 includes trunk cables 20 extending between the main building 12 and each of the auxiliary buildings 14. Conventional trunk cables 20 generally include a high fiber-count arrangement of optical fibers for passing data and other information through the local fiber optic network 16. In the example illustrated in FIG. 1, the trunk cables 20 from the auxiliary buildings 14 are routed to one or more distribution cabinets 22 housed in the main building 12 (one shown).

Within the main building 12, a plurality of indoor fiber optic cables 24 are routed between the network equipment 18 and the one or more distribution cabinets 22. The indoor cables 24 generally include a high fiber-count arrangement of optical fibers for passing data and other information from the distribution cabinets 22 to the network equipment 18. Although only the interior of the main building 12 is schematically shown in FIG. 1 and discussed above, each of the auxiliary buildings 14 may house similar equipment for similar purposes. Thus, although not shown, each of the trunk cables 20 may be routed to one or more distribution cabinets 22 in one of the auxiliary buildings 14 in a manner similar to that described above. Furthermore, each of the auxiliary buildings 14 may include indoor cables 24 that extend between network equipment 18 and the one or more distribution cabinets 22 of the auxiliary building 14. Though a data center 10 is shown in FIG. 1, It should be understood that the disclosed invention has wide ranging utility beyond a data center 10 context. For example, the disclosed invention may be used in FTTx and other applications.

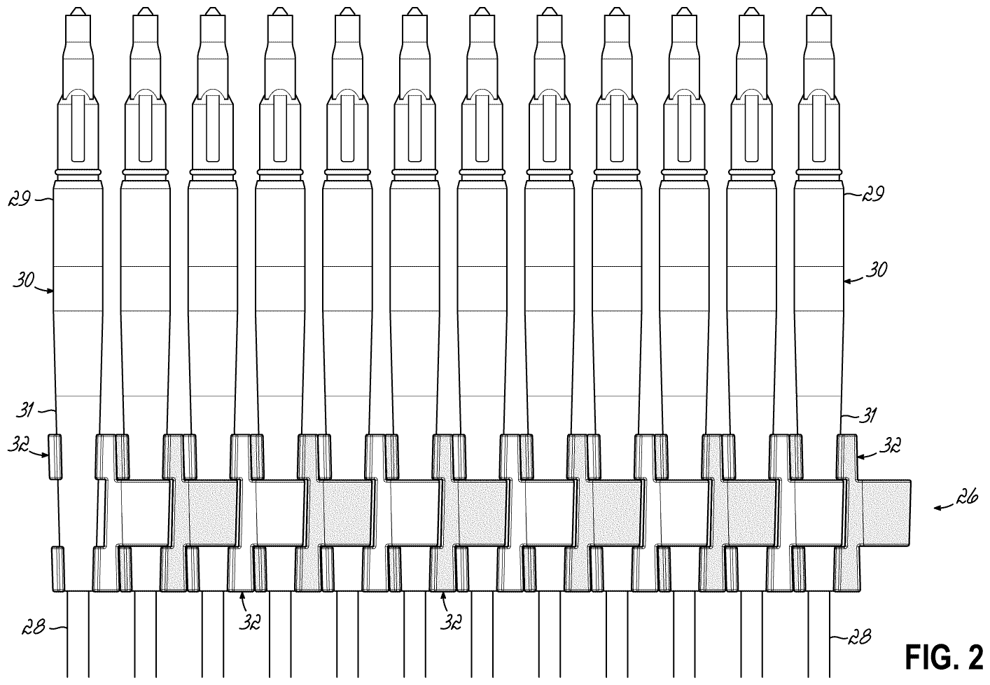

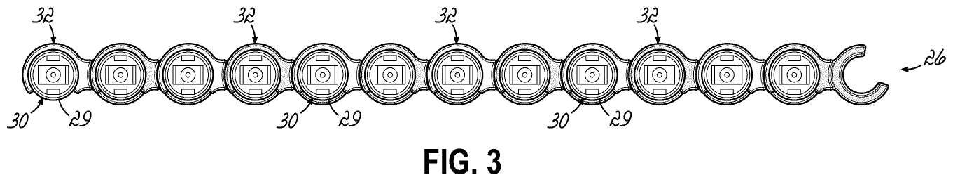

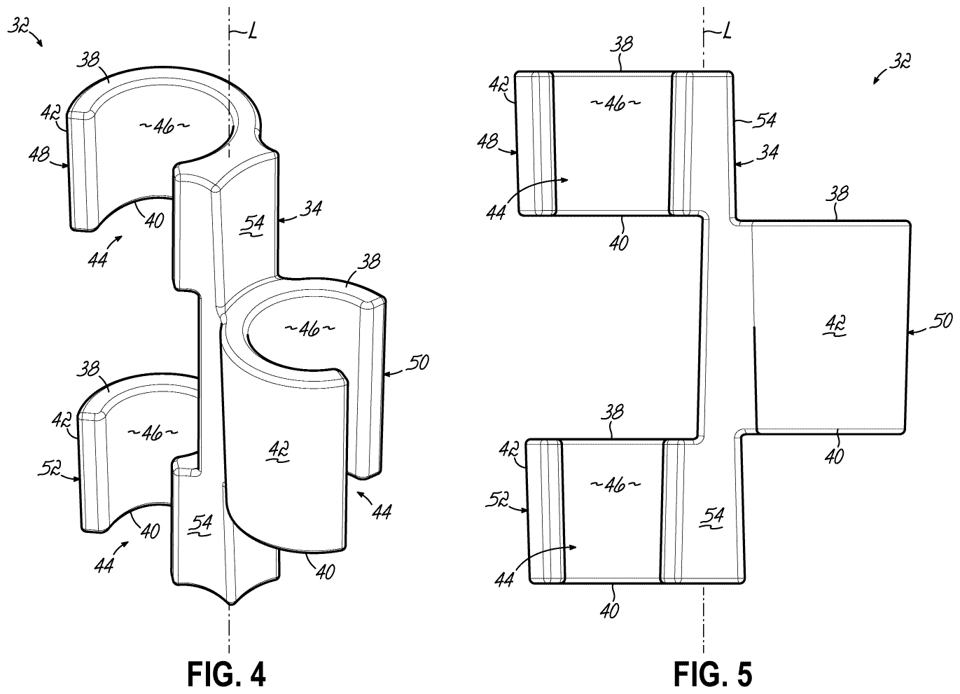

Referring now to FIGS. 2 and 3, the figures show an embodiment of a linkage chain 26 attached to a number of fiber optic cables 28. The fiber optic cables 28 may be subunits (or legs) of either a trunk cable 20 or an indoor fiber optic cable 24, for example, or may be discrete fiber optic cables. The linkage chain 26 is a flexible and scalable solution for routing and/or storing (or “parking”) fiber optic cables 28, for example. Particularly, in the embodiment shown, each fiber optic cable 28 includes a fiber optic connector 30 at an end thereof. A portion of each fiber optic connector 30 is releasably secured by an individual linkage 32 (in a manner to be described in greater detail below with respect to FIGS. 4 and 5). Each linkage 32 is further configured to secure one fiber optic connector 30 to a neighboring fiber optic connector 30. Thus, a number of individual linkages 32 (and their respective fiber optic cables 28) can be assembled to form a linkage chain 26. While the linkages 32 and linkage chain 26 are described herein with specific utility for fiber optic cables 28, it should be understood that the linkages 32 and/or linkage chain 26 may be used with other types of cables, such as copper communication cables, electric power cables, etc. Additionally, although the linkages 32 are shown and described as being releasably secured to the fiber optic connectors 30, in alternative embodiments the linkages 32 may be secured to other portions of the fiber optic cables 28, such as to an outer jacket of a fiber optic cable 28 (e.g., adjacent the fiber optic connector 30).

The fiber optic connectors 30 may be of any known or yet to be developed type. In the embodiment shown, the fiber optic connectors 30 are in the form of ruggedized (or “hardened”) connectors available from Corning Optical Communications LLC (“Corning”) and referred to as Pushlok™ connectors. Additional details relating to these connectors and variants thereof can be found, for example, in the following patent or patent application publication numbers: U.S. Pat. Nos. 10,359,577; 10,379,298; 10,802,228; 10,809,463; US2020/0103599; and US2020/0096710, wherein the disclosures of each of the foregoing publications are fully incorporated herein by reference. In alternative embodiments, the fiber optic connectors 30 may be configured as another type of ruggedized connector, such as an OptiTap® connector available from Corning, a Prodigy™ connector available from CommScope, Inc. of North Carolina, or a FastConnect™ connector available from Huawei Technologies Co., Ltd. In yet other embodiments, the fiber optic connectors 30 may be in form of a traditional, non-ruggedized connector, such as a standard LC connector or MPO (multi-fiber push on) connector. Examples of more recently-developed connector types include MMC connectors commercially available from US Conec Ltd. and SN-MT connectors commercially available from Senko Advanced Components, Inc.

In general, the fiber optic connector 30 includes a connector body 29 and a boot 31 that provides a transition from the connector body 29 to the adjacent portion of the fiber optic cable 28. The boot 31 is generally tapered along its length in the embodiment shown, and as will be described in greater detail below, the linkages 32 may be configured to complement such geometry. Again, however, the embodiment shown in merely an example. In alternative embodiments, the linkages 32 may be releasably secured to another portion of the fiber optic connectors 30 (e.g., the connector body 29) or to an adjacent portion of the fiber optic cables 28.

Referring now to FIGS. 4 and 5, the figures show an embodiment of an individual linkage 32. The linkage 32 includes a central body 34 extending in a direction along a longitudinal axis L. A number of cuffs 36 extend from the central body 34 in directions transverse to the longitudinal axis L of the central body 34. More particularly, the cuffs 36 are operatively connected to the central body 34 and are, respectively, configured to each releasably receive a portion of the fiber optic connector 30. In the depicted embodiment, the cuffs 36 are roughly C-shaped, though it should be understood that alternative forms of the cuffs 36 are possible. The cuffs 36 are each defined by a top face 38, a bottom face 40, and a lateral face 42. The lateral face 42 includes an opening 44 to permit a fiber optic connector 30, for example, to enter and exit an interior 46 of the cuff 36 (so as to be secured and unsecured, respectively).

In the depicted embodiment, the linkage 32 features three cuffs 36-a first cuff 48, a second cuff 50, and a third cuff 52. It should be understood that alternative embodiments of the linkage 32 may have fewer or more than three cuffs 36. The first cuff 48 and third cuff 52 extend in the same direction transverse to the longitudinal axis L of the central body 34. Further, the first cuff 48 and the third cuff 52 may be aligned along a common axis with each other such that the same fiber optic connector 30 can be inserted into both the first cuff 48 and the third cuff 52. The second cuff 50 extends in an opposing (e.g., to the first cuff 48 and third cuff 52) direction transverse to the longitudinal axis L of the central body 34. The second cuff 50 is located, with respect to the longitudinal axis L of the central body 34, between the first cuff 48 and the third cuff 52. It should be understood that the cuffs 36 could be alternatively located or arranged along the longitudinal axis L of the central body 34. Another fiber optic connector 30 (distinct from the fiber optic connector 30 received in the first cuff 48 and third cuff 52) is received by the second cuff 50. Thus, assembling a number of linkages 32 (which each link one fiber optic cable 28 to a neighboring fiber optic cable 28) forms a linkage chain 26 which secures a number of fiber optic cables 28 together.

With continued reference to FIGS. 4 and 5, while the illustrated embodiment shows cuffs 36 extending in opposite directions (e.g., 180 degrees from each other relative to the longitudinal axis L of the central body 34), it should be understood that, in alternative embodiments, the cuffs 36 may not extend in opposing directions. In other words, one cuff 36 (e.g., the second cuff 50) may be arranged at an angle (relative to the longitudinal axis L of the central body 34) to the other cuffs 36 (e.g., the first cuff 48 and the third cuff 52) that is less than 180 degrees-such an angle may be 45 degrees, 60 degrees, 90 degrees, 120 degrees, or 135 degrees, for example.

Further, in the depicted embodiment, the opening 44 in the lateral face 42 of the first cuff 48 and the third cuff 52 is not oriented in the same direction as the opening 44 in the lateral face 42 of the second cuff 50. Instead the opening 44 in the lateral face 42 of the first cuff 48 is in the same direction as the opening 44 in the lateral face 42 of the third cuff 52. More particularly, the opening 44 in the lateral face 42 of the first cuff 48 and the third cuff 52 is in a direction transverse to the longitudinal axis L of the central body 34 and opposite to the direction of the opening 44 in the lateral face 42 of the second cuff 50. Such opposing orientation facilitates the arrangement of the linkages 32 into a linkage chain 26. As shown in FIGS. 2 and 3, for example, the opposing orientation of the respective openings 44 helps to prevent a fiber optic cable 28 (or, more specifically for the embodiment shown, a fiber optic cable connector 30) from unintentionally being removed from the linkage chain 26. As will be explained in greater detail below, one would have to manipulate (e.g., rotate) the linkage chain 26 in a particular manner to remove a fiber optic cable 28 from the linkage chain 26. However, it is to be understood that, in alternative embodiments, the openings 44 in the cuffs 36 could be alternatively arranged.

With specific reference to FIG. 5, the figure illustrates that the cuffs 36 are tapered in a direction parallel to the longitudinal axis L of the central body 34. Specifically, the radius of the first cuff 48, for example, at the top face 38 of the first cuff 48 is greater than the radius of the first cuff 48 at the bottom face 40 of the first cuff 48. As shown, the interior 46 of the first cuff 48 smoothly tapers from the top face 38 of the first cuff 48 to the bottom face 40 of the first cuff 48. In the depicted embodiment, both the second cuff 50 and third cuff 52 are similarly tapered. However, it should be understood that in alternative embodiments the cuffs 36 may not be tapered. Further, in the depicted embodiment, the taper of the first cuff 48 continues to the third cuff 52. In other words, the radius of the bottom face 40 of the first cuff 48 is greater than the radius of the top face 38 of the third cuff 52. More particularly, the taper angle of the interior 46 of the first cuff 48 and the taper angle of the interior 46 of the third cuff 52 may be substantially the same despite the first cuff 48 and the third cuff 52 being structurally disjointed (e.g., not continuous).

With reference to FIGS. 4 and 5, the linkage 32 may be applied to the fiber optic cable 28 (specifically, the fiber optic connector 30 of the fiber optic cable 28 in the embodiment shown) during a fiber optic cable 28 manufacturing process. Such would allow the linkages 32 to be used for organizing the fiber optic cables 28 and/or fiber optic connectors 30 during the fiber optic cable 28 manufacturing process, and may allow other cable management or identification features to be incorporated. For example, the linkages 32 may feature one or more labelling spaces 54 where a label (e.g., a sticker or written indicia) could be applied. It is to be understood that the labelling function of the linkages 32 has wider applicability beyond the manufacturing process. For example, the linkages 32 could be used to label stored (or “parked”) fiber optic cables 28 or fiber optic connectors 30. Further, applying a linkage 32 to a fiber optic cable 28 prior to the fiber optic cable 28 arriving at an installation site would allow one to readily utilize the linkages 32 (specifically, a linkage chain 26 including a number of fiber optic cables 28) for routing and/or storing (or “parking”) the fiber optic cables 28 at the installation site. Such will be addressed in greater detail below.

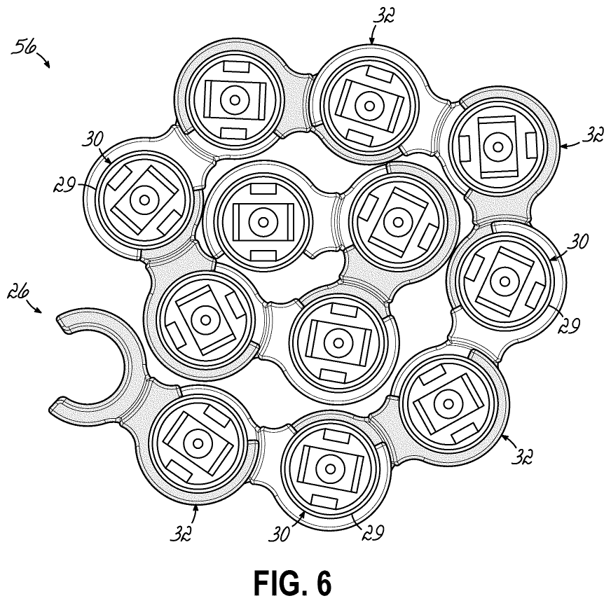

Referring now to FIG. 6, the figure illustrates an embodiment of the linkage chain 26 in a bundle 56. To bundle the linkage chain 26, one pivots the linkage 32 at one of the two ends of the linkage chain 26 to form roughly a “V” shape between the linkage 32 and its neighboring linkage 32. The remaining linkages 32 are then wrapped around the pivoted end linkage 32 and its neighboring linkage 32 (e.g., in a spiral formation) to form a roughly circular linkage chain 26 bundle 56. Bundling the linkage chain 26 in this manner tightly packs the linkages 32 (and thus fiber optic cables 28 and fiber optic connectors 30) together and reduces the overall outer diameter of the linkage chain 26. Such bundling may be advantageous for routing and/or storing (or “parking”) the fiber optic cables 28 and helps to reduce or eliminate snagging (e.g., on adjacent fiber optic cables 28 or network equipment 18, for example). It should be understood that the linkage chain 26 may be bundled in alternative ways and form alternative bundled shapes (e.g., besides circular). For example, to route through a particular pathway it may be desirable to arrange the linkage chain 26 in a long and skinny arrangement (e.g., “flat” as shown in FIGS. 2 and 3). Such is possible with the linkage chain 26. And the linkage chain 26 offers the additional benefit of maintaining the sequence (e.g., order) of fiber optic cables 28 even as the shape of the linkage chain 26 bundle 56 is changed and without requiring the linkage chain 26 to be broken.

With respect to routing, reducing the outer diameter of the linkage chain 26 by bundling the linkage chain 26 into a bundle 56 allows for the bundled linkage chain 26 to be routed more easily through a pathway (e.g., conduits, ducts, raceways, etc.) from one location to another. Such reduces or eliminates the need for a separate pulling grip to cover the fiber optic connectors 30, for example, which may also reduce installation packaging and waste because pulling grips are frequently thrown away after use. In contrast, the linkages 32 (and thus linkage chain 26) may be used and reused so long as the linkages 32 are in working order. Further, reducing or eliminating the need for a pulling grip also helps to increase installation efficiency (e.g., reduce installation time). As mentioned above, linkages 32 can be installed on fiber optic cables 28 during the fiber optic cable 28 manufacturing process. This saves an installer from having to spend time applying a pulling grip, for example, to an end of a fiber optic cable 28 or cables 28.

With continued reference to FIG. 6, arranging fiber optic cables 28 (and fiber optic connectors 30) in the linkage chain 26 also facilitates storing (or “parking”) the fiber optic cables 28 (and fiber optic connectors 30). For example, when connecting buildings 12, 14 of data center 10, it may be necessary to temporarily store (or “park”) unused fiber optic connectors 30 in an organized manner. Such can be accomplished with the linkage chain 26. More specifically, the linkage chain 26 solves the issue of needing to keep fiber optic cables 28 (and fiber optic connectors 30) grouped and organized in an easy to access area. Additionally, the functionality to bundle the fiber optic connectors 30 in a bundle 56 with the linkage chain 26 makes arranging the fiber optic cables 28 into position easier. With existing solutions, loose fiber optic cable connectors 30 would be more likely to snag installed fiber optic cables 28 and also would require installers to carefully untangle and reroute individual fiber optic cables 28 as necessary. Such issues are avoided with the linkage chain 26. And further, advantageously, the linkage chain 26 (particularly, the linkage chain 26 when in a bundle 56) takes up far less space than existing solutions to the storing (or “parking”) issue. Moreover, the amount of space taken up by the linkage chain 26 bundle 56 decreases as fiber optic cables 28 are removed from the linkage chain 26 as needed. Thus, the linkage chain 26 offers the additional benefit of becoming more space efficient over time.

Referencing now generally FIGS. 1-6, an exemplary method of using the linkage chain 26 to releasably secure at least one fiber optic connector 30 will now be described. As mentioned above, the linkages 32 may be added to the fiber optic cables 28 during a manufacturing process. To form the linkage chain 26, a number of linkages 32 (and thus fiber optic cables 28 and fiber optic connectors 30) are joined together.

According to one embodiment, the process of joining together two linkages 32 to form a linkage chain 26 starts with the fiber optic connector 30. The fiber optic connector 30, held by the first cuff 48 and the third cuff 52 of the first linkage 32, is slid upwards in the direction of the longitudinal axis L of the central body 34 of the first linkage 32. Because of the taper of the first cuff 48 and third cuff 52 of the first linkage 32, sliding the fiber optic connector 30 upwards releases the fiber optic connector 30 from the first cuff 48 and the third cuff 52. With the fiber optic connector 30 released, a second linkage 32 can be introduced. Specifically, the second cuff 50 of the second linkage 32 can be introduced between the first cuff 48 and the third cuff 52 of the first linkage 32. Like the first cuff 48 and the third cuff 52 of the first linkage 32, the second cuff 50 of the second linkage 32 is also tapered. Particularly, the second cuff 50 is tapered in such a way as to form a substantially continuous taper from the first cuff 48 of the first linkage 32 to the second cuff 50 of the second linkage 32 to the third cuff 52 of the first linkage 32 despite being structurally disjointed. In other words, the taper angle of the interiors 46 of the first cuff 48, the second cuff 50, and the third cuff 52 may be substantially the same. In some embodiments, one may orient the first linkage 32 and the second linkage 32 such that the respective openings 44 of the cuffs 36 are aligned so as to facilitate easier entry of the fiber optic connector 30 into the interior 46 of the cuffs 36.

With continued reference to FIGS. 1-6, after locating the second cuff 50 of the second linkage 32 between the first cuff 48 and the third cuff 52 of the first linkage 32, the fiber optic connector 30 can then be slid downwards in the direction of the longitudinal axis L of the central body 34 of the first linkage 32 (e.g., in the opposite direction of the previous slide). Sliding the fiber optic connector 30 into place (e.g., as to be releasably secured) in the first cuff 48 and the third cuff 52 of the first linkage 32 and the second cuff 50 of the second linkage 32 secures the first linkage 32 and the second linkage 32 together via the fiber optic connector 30 (i.e., the fiber optic connector 30 is what connects the first linkage 32 and the second linkage 32 to each other). The same process can be repeated to join a number of fiber optic cables 28 together via linkages 32 to form a linkage chain 26. Notably, the same process can also be used to join two linkage chains 26 together. For example, if one has two or more existing linkage chains 26, those linkage chains 26 can be joined together (e.g., to form a longer linkage chain 26) by following the above process with linkages 32 on corresponding extreme ends of the existing linkage chains 26.

The process of removing a linkage 32 from a linkage chain 26 is similar to the above outlined process for joining linkages 32 to form a linkage chain 26 but executed in reverse order. In short, one would start with a linkage chain 26 and determine where it is desired to break that linkage chain 26. One would then slide the selected fiber optic connector 30 upwards in the direction of the longitudinal axis L of the central body 34 of the attached linkage 32. In some embodiments, one may rotate the first linkage 32 and the second linkage 32 such that the respective openings 44 of the cuffs 36 are aligned so as to facilitate easier removal of the fiber optic connector 30 from the interior 46 of the cuffs 36. With the fiber optic connector 30 released from the grasp of the first cuff 48 and the third cuff 52 of its own linkage 32 as well as the second cuff 50 of its neighboring linkage 32, one is free to separate the neighboring linkage 32 from the linkage chain 26. The fiber optic connector 30 can then be slid downwardly in the direction of the longitudinal axis L of the central body 34 of the attached linkage 32 to resecure the fiber optic connector 30 within its own linkage 32 (and to the remainder of the linkage chain 26). The same process can be repeated to remove a number of fiber optic cables 28 from a linkage chain 26. Notably, the same process can also be used to divide an existing linkage chain 26 into two or more (smaller) separate linkage chains 26 at any desired location of the linkage chain 26 (e.g., at any internal location along the linkage chain 26). For example, if one has a long linkage chain 26 (e.g., perhaps after routing a large linkage chain 26 bundle 56 of fiber optic cables 28 through a pathway) one may then divide that linkage chain 26 or remove individual fiber optic cables 28 (and fiber optic connectors 30) from the linkage chain 26 as desired by following the above-outlined removal process.

With continued reference to FIGS. 1-6, the above-outlined processes of joining linkages 32 to form a linkage chain 26 and removing linkages 32 from a linkage chain 26 can be used together to reconfigure the order of fiber optic cables 28 (and fiber optic connectors 30) within a linkage chain 26. In other words, fiber optic cables 28 (and fiber optic connectors 30) can be removed and added to a linkage chain 26 at will to arrive at a desired order of the fiber optic cables 28 (and fiber optic connectors 30).

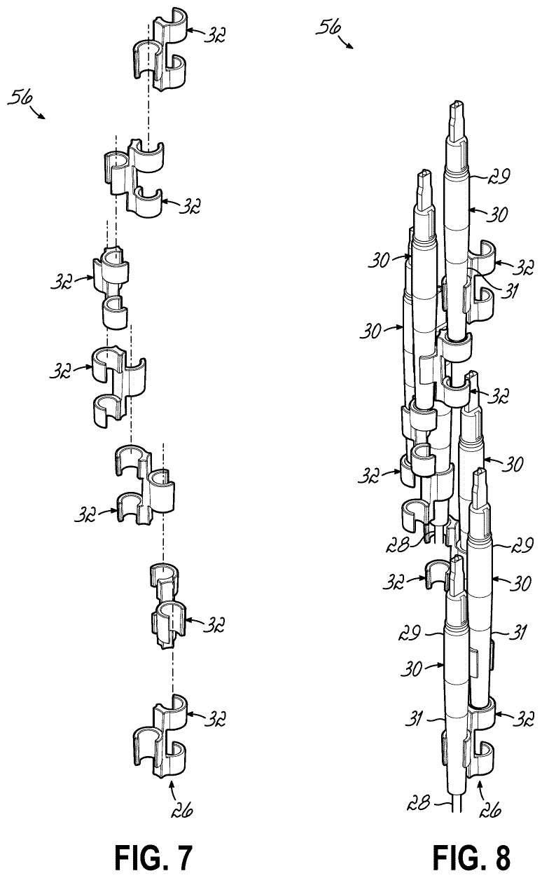

Referring now to FIGS. 7 and 8, the figures illustrate an alternative embodiment of a linkage chain 26 bundle 56. As best shown in FIG. 7, the linkages 32 are staggered in the direction of the longitudinal axis L of the central body 34 of the linkage 32. Particularly, the second cuff 50 of each linkage 32 is arranged either above the first cuff 48 of a neighboring linkage 32 or below the third cuff 52 of a neighboring linkage 32. In other words, each linkage 32 is located longitudinally above or below a neighboring linkage 32. For example, as shown in FIGS. 7 and 8, the second cuff 50 of a linkage 32 may be aligned along a common axis with the first cuff 48 of a neighboring linkage 32 such that the same fiber optic connector 30 can be inserted into the second cuff 50 of a linkage 32 and into the first cuff 48 of a neighboring linkage 32 to form a linkage chain 26. As best shown in FIG. 8, such longitudinal staggering of the linkages 32 to form the linkage chain 26 allows for a tighter bundle 56 of the linkage chain 26 (in comparison to the bundle 56 shown in FIG. 6, for example). In other words, the outer diameter of the linkage chain 26 bundle 56 shown in FIGS. 7 and 8 is further reduced (e.g., in comparison to the linkage chain 26 bundle 56 shown in FIG. 6). Such may be desirable for fiber optic cable 28 routing and/or storage (or “parking”). A further reduced outer diameter may allow an installer to route the linkage chain 26 bundle 56 through a tighter (e.g., narrower) pathway (e.g., in comparison to the linkage chain 26 bundle 56 shown in FIG. 6). Additionally, a further reduced outer diameter may allow an installer to store (or “park”) the fiber optic cable 28 bundle 56 in smaller space or, at least, further reduce the amount of space taken up by storing (or “parking”) the fiber optic cable 28 bundle 56.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The disclosure in its broader aspects is therefore not limited to the specific details, representative apparatus and methods and illustrative examples shown and described. Accordingly, departures may be made from such details without departing from the scope of the disclosure.

What is claimed is:

1. A linkage for releasably securing a cable, the linkage comprising:
a central body having a longitudinal axis;
at least two cuffs that are each operatively connected to the central body and that are each defined by a top face, a bottom face, and a lateral face, the lateral face having an opening such that each cuff of the at least two cuffs is configured to releasably receive a portion of the cable therein,
wherein the at least two cuffs includes a first cuff and a second cuff, and wherein the first cuff and the second cuff extend in opposing directions transverse to the longitudinal axis of the central body.

2. The linkage of claim 1, wherein a radius of the first cuff at the top face is greater than a radius of the first cuff at the bottom face.

3. The linkage of claim 1, wherein a radius of the second cuff at the top face is greater than a radius of the second cuff at the bottom face.

4. The linkage of claim 1, wherein the at least two cuffs includes a third cuff, and wherein the third cuff extends in the same direction as the first cuff and is aligned with the first cuff.

5. The linkage of claim 4, wherein a radius of the third cuff at the top face is greater than a radius of the third cuff at the bottom face.

6. The linkage of claim 4, wherein a radius of the first cuff at the bottom face is greater than the radius of the third cuff at the top face.

7. The linkage of claim 4, wherein the second cuff is located between the first cuff and the third cuff along the longitudinal axis of the central body.

8. The linkage of claim 4, wherein the opening in the lateral face of the first cuff is transverse to the longitudinal axis of the central body, and wherein the opening in the lateral face of the third cuff is in the same direction as the opening in the lateral face of the first cuff.

9. The linkage of claim 1, wherein the opening in the lateral face of the first cuff and the opening in the lateral face of the second cuff are in opposing directions transverse to the longitudinal axis of the central body.

10. The linkage of claim 1, wherein the linkage includes a labeling space.

11. A cable arrangement comprising:
a first cable and a second cable; and
a linkage chain comprising a first linkage and a second linkage, wherein the first linkage and the second linkage include a central body and a first cuff, a second cuff, and a third cuff operatively connected to the central body, wherein each of the first cuff, the second cuff, and the third cuff has a lateral face with an opening so as to be configured to releasably receive a portion of the first cable or the second cable therein, and wherein the first cuff and the third cuff extend from the central body in a direction opposite that of the second cuff,
wherein the first cable is releasably received by the first cuff and the third cuff of the first linkage, and wherein the second cable is releasably received by the second cuff of the first linkage and by the first cuff and the third cuff of the second linkage to form the linkage chain.

12. The cable arrangement of claim 11, wherein the second cuff of the first linkage is located between the first cuff and the third cuff of the second linkage.

13. The cable arrangement of claim 11, further comprising
a third cable; and
a third linkage, wherein the second cable is releasably received by the first cuff and the third cuff of the second linkage, and wherein the third cable is releasably received by the second cuff of the second linkage and by the first cuff and the third cuff of the third linkage to form part of the linkage chain.

14. The cable arrangement of claim 11, wherein the first cable and the second cable are each fiber optic cables that include a fiber optic connector on an end thereof, and wherein the first cuff, the second cuff, and the third cuff each releasably receive a portion of the fiber optic connector of the first cable or the second cable therein.

15. A method of arranging at least two cables using a linkage chain that includes at least a first linkage and a second linkage, wherein the first linkage and the second linkage each include a central body and a first cuff, a second cuff, and a third cuff operatively connected to the central body, the method comprising:
releasably securing a first cable of the at least two cables to the first cuff and the third cuff of the first linkage; and
releasably securing a second cable of the at least two cables to the second cuff of the first linkage and to the first cuff and the third cuff of the second linkage to form the linkage chain.

16. The method of claim 15, wherein the first cable and the second cable are each fiber optic cables that include a fiber optic connector on an end thereof, and wherein the first cuff, the second cuff, and the third cuff each releasably secure a portion of the fiber optic connector of the first cable or the second cable therein.

17. The method of claim 15, wherein the step of releasably securing the second cable includes receiving the second cuff of the first linkage on the second cable at a longitudinal location on the second cable that is above or below where the second linkage is received on the second cable.

18. The method of claim 15, further comprising:
pivoting the first linkage towards the second linkage about the second cable to reduce an overall outer diameter of the linkage chain.

19. The method of claim 18, further comprising:
routing the linkage chain through a pathway after the step of pivoting the first linkage.

20. The method of claim 19, further comprising:
removing the first linkage from the second cable
